(19) United States
(12) Patent Application Publication
(10) Pub. No.: US 2021/0404603 A1
(43) Pub. Date: Dec. 30, 2021

(54) COMPRESSED GAS STORAGE UNIT WITH PREFORMED ENDCAPS

(71) Applicant: NEEL SIROSH, IRVINE, CA (US)

(72) Inventor: NEEL SIROSH, IRVINE, CA (US)

(73) Assignee: H2NG Global LLC, Irvine, CA (US)

(21) Appl. No.: 17/380,317

(22) Filed: Jul. 20, 2021

(51) Int. Cl. F17C 1/16; F17C 1/14

(52) U.S. Cl. CPC F17C 1/16; F17C 1/14; F17C 2201/0109; F17C 2203/0646; F17C 2203/0673; F17C 2209/2154; F17C 2209/234; F17C 2203/0619

(57) ABSTRACT

Embodiments are directed to fiber-reinforced compressed gas storage tanks or vessels comprising one or more shells that are made by metal forming, plastic molding, braiding, filament-winding, or fiber placement. Particular embodiments employ one or more discrete pre-formed fiber-reinforced endcaps with fibers oriented in preferential angles that are integrated to the vessel end-domes to reinforce the polar openings and the dome-cylinder transition areas of the load carrying shells.

### CROSS-REFERENCE TO RELATED APPLICATIONS

The instant nonprovisional patent application claims priority to the following provisional application which is incorporated by reference in its entirety herein for all purposes: U.S. Provisional Patent Application No. 63,220,454, filed on Jul. 9, 2021.

### BACKGROUND

Recently, there is a growing focus on shifting from polluting fossil fuels to sustainable mobility solutions using hydrogen gas. Accordingly, it is desirable to be able to store compressed gas within a tank or other pressure vessel in an efficient manner, at the highest capacity, lowest possible weight, and a reduced cost.

Another emerging trend is the increasing availability of natural gas as a fuel source. Such natural gas may be stored on-board in gaseous form as compressed natural gas (CNG), with economic merits of CNG being dependent upon density of the stored CNG. Again, it is desirable to store compressed gas within a tank or other pressure vessel in a efficient manner, at the highest capacity, lowest possible weight, and a reduced cost.

On-board storage of gaseous hydrogen fuel involves pressures ranging from 20 MPa to 85 MPa and natural gas fuel involves pressures ranging from 20 MPa to 25 MPa. Tanks or pressure vessels comprising a polymer or metallic shell that is overwrapped by continuous filament reinforcements have been used for hydrogen and natural gas on-board fuel storage since the 90's. Such fiber-reinforced tanks or pressure vessels are typically 90% lighter than all-steel tanks but continue to be significantly expensive.

Sirosh et al (U.S. Pat. Nos. 5,253,778, 5,494,188, 5,938,209, 9,618,157) have disclosed methods to fabricate fiber-reinforced tanks or pressure vessels with an inner shell or liner and fiber-reinforced composite outer layers that are placed on the liner in its entirety but do not teach the use of localized end-domes to optimize the structure to reduce its weight and cost.

Wood et al (U.S. Pat. No. 8,858,857) have disclosed a method to fabricate fiber-reinforced tanks or pressure vessels at a high rate using dry fiber preform or braid that is placed on a liner in its entirety and further injected with resin but do not teach the use of localized end-domes to optimize the structure to reduce its weight and cost.

Weisberg (U.S. Pat. No. 8,545,657) has disclosed a method to rapidly build fiber-reinforced structures by placing resinated filament layers on a mandrel, however doe snot teach optimization of tanks or pressure vessels.

Wexler et al (U.S. Pat. No. 11,000,988) have disclosed a method to fabricate long braided tubes with resinated filaments and bend them into conformable-shaped pressure containment units, but do not teach the use of localized reinforcements to reduce weight and cost.

The embodiment disclosed herein relates to an optimized tank or pressure vessel, and a process for producing an optimized tank or pressure vessel.

### SUMMARY

Certain embodiments are directed to tanks or pressure vessels that have an inner corrosion resistant and permeation resistant shell made of aluminum alloy or thermoplastic polymer, and an outer concentric shell that includes high strength fiber-reinforcement utilizing a combination of traditional filament winding, high-speed tubular braiding and/or fiber placement. Embodiments employ pre-formed endcaps that are incorporated in the end-domes of the tanks or pressure vessels. In certain embodiments the pre-formed endcaps are configured with fiber reinforcements in a predominantly hoop direction with respect of the axis of the tank or pressure vessel. In other embodiments the pre-formed endcaps are configured with fiber reinforcements in a predominantly longitudinal direction with respect to the axis of the tank or pressure vessel.

### BRIEF DESCRIPTION OF THE DRAWINGS

FIG. 1 is a cut-away view of an implementation of a gas tank or pressure vessel with an inner corrosion resistant and permeation resistant shell and outer composite shell that comprise fiber reinforcements over the end-domes and the straight cylindrical portion.

FIG. 2 is a cut-away view of an implementation of a gas containment tank or pressure vessel with the inner corrosion and permeation resistant shell, outer composite shell that comprise fiber reinforcements and incorporate prefabricated endcaps at the end-dome portions.

FIG. 3 is a cut-away view of an implementation of prefabricated endcap with fibers predominantly oriented in the “hoop” direction with respect to the longitudinal axis of the tank or vessel, to provide beneficial localized reinforcement around the polar opening to prevent premature “boss blow out” failure, as well as fibers predominantly oriented in the longitudinal direction in the knee area of the end-domes, to prevent “flower burst” from the bending stresses at the dome to cylinder transition.

FIG. 4 shows the equilibrium between the internal pressure in a pressure vessel and the wall stresses of the tank or pressure vessel to balance the hoop and longitudinal pressure loads.

FIG. 5 is a graph showing the relationship between circumference of the inner shell or mandrel, braiding angle and areal weight of the fiber-reinforcement that is deposited by the braiding process on the liner mandrel, to illustrate the limitations of the braiding process.

### DESCRIPTION

The following detailed description is of the best presently contemplated modes of carrying out the invention. This description is not to be taken in a limiting sense but is made merely for the purpose of illustrating general principles of embodiments of the invention. The scope of the invention is best defined by the appended claims.

Compressed gas tanks or pressure vessels are commonly cylindrical in shape with a straight cylindrical portion that is capped by two end-domes with or without polar openings to accommodate entry and egress of gas. Lightweight tanks or vessels are manufactured by overwrapping an inner shell as the corrosion-resistant and permeation-resistant liner with high strength fiber-reinforcement, either by filament winding, braiding or fiber placement methods. These processes are sometimes co-mingled.

Filament-winding process involves impregnating continuous fiber-reinforcement in a resin and winding over the rotating liner core, while moving parallel to the core, to achieve a ply structure consisting of cross and circumferential windings. Dry winding, without resin or little resin is also feasible.

Braiding process involves placing dry filaments on the liner core and achieving crossing and intertwining of the filaments by revolving and oscillating bobbins. In some cases, the dry filament preform is infused with a resin using a process such as resin transfer molding. Both methods have their advantages and disadvantages in orienting reinforcing fibers most efficiently to carry the pressure loads to achieve weight and cost minimization.

Fiber placement involves patches of fiber-resin fabric on a rotating liner core, to achieve a ply structure consisting or fibers oriented in pre-determined directions, for optimal structural performance.

The end-domes of fiber-reinforced tanks or pressure vessels experience high stresses around the polar openings and hence more susceptible to failure than the cylindrical part. A concentrated amount of reinforcing fibers oriented in the circumferential (“hoop”) direction around the openings is helpful to manage the high stresses around the polar openings.

The end-domes of fiber-reinforced tanks or pressure vessels experience high stresses at the “knee” area, or the transition between the cylindrical area and the domes. Fibers generally oriented in the longitudinal direction by the knee region helps to reduce the bending stresses in this region.

The straight cylindrical part of fiber-reinforced tanks or pressure vessels requires considerable circumferential reinforcement since the stresses in the circumferential direction is always double that of the stresses in the longitudinal direction. An optimum design needs to accommodate these different, and seemingly conflicting requirements—a high burst pressure and a large internal volume at the lowest possible weight and cost. This makes the design and manufacture of optimum pressure vessels a considerably complex optimization problem.

Filament winding works well to build the end domes since the thickness of the plies increases inversely proportional to the radius, thereby achieving a thick layer around the polar openings. Additionally, filament winding allows building near-longitudinal angles at the knee region, to support the bending stresses in that transitional region. However, to use filament winding to fulfill these localized reinforcing necessities, the continuous filaments need to traverse the entire cylindrical region, from fore end-dome to the aft end-dome. This constraint leads to excessive material usage, resulting in significant disadvantages in terms of weight and cost. Filament winding is also relatively slow, due to the common requirement to impregnate the fiber with wet resin. However, filament winding allows placement of near-circumferential “hoop” filaments, which are essential to carry the high stresses in the cylindrical portion of the vessel.

Braiding is one of the most versatile and cost-efficient processes for production of fiber preforms for building fiber-reinforced composite shells. Braiding is cost-efficient due to its layup speed and reduced material waste, which is even more important when expensive carbon fibers are used. Building a pressure vessel using braiding, however, is challenging since braiders are specialized for the manufacturing of fiber layers with fiber directions between 20° and 70° with respect to the longitudinal axis. Pressure vessels generally requires 90° layers around the dome polar openings and across the straight cylindrical section. Unlike in filament winding where there is a geometric relationship between the fiber angle and the radius of the core, the fiber angle in braiding depends on the relative speed of the bobbins and the take up. A smaller angle is the result of a faster take-up speed. To build thickness around the polar openings, the fiber tow may have to be narrowed, which leads to overlaps, distortion of fiber alignment and subsequent reduction in material properties.

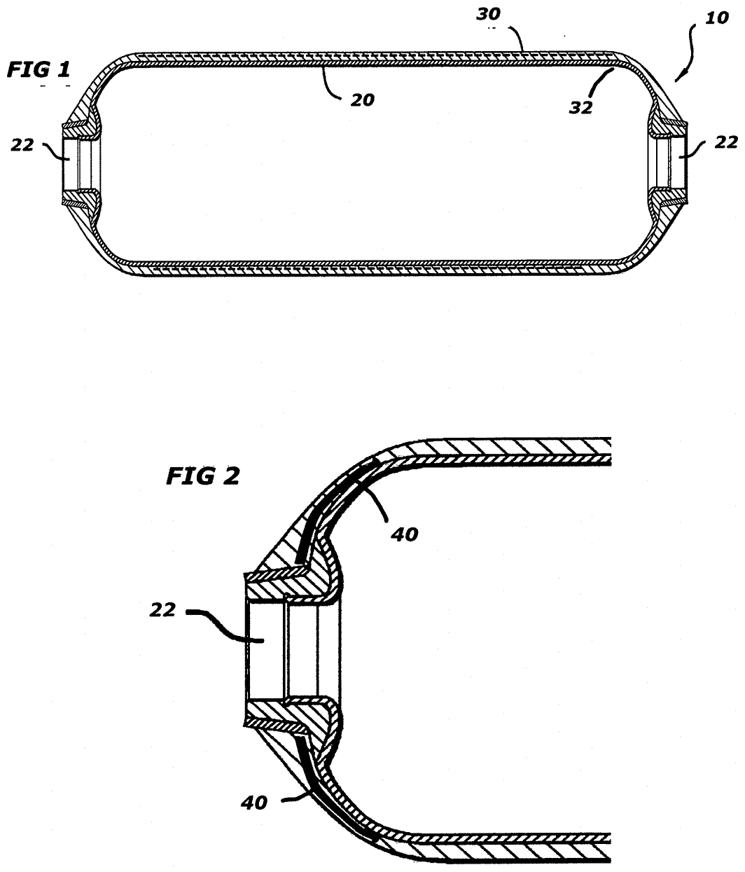

FIG. 1 shows a high-pressure gas containment tank or vessel 10 having two concentric shells and one or two polar openings. Vessel 10 includes an inner shell 20 that is configured to enclose gas, and an outer shell 30 that provides structural load carrying capability to balance the radial and axial loading from internal gas pressure. Vessel 10 may have one of a variety of shapes, including cylindrical, spherical, or combinations thereof. The pressure vessel 10 may be axially symmetric about the axis extending along a longitudinal length of the vessel 10. The vessel 10 may include a cylindrical region and two dome regions at opposing ends thereof. The outer shell may include multiple fiber reinforcement layers including predominantly hoop fiber layers 32.

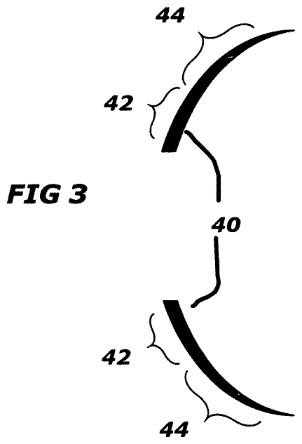

FIG. 2 shows an embodiment of the present invention, pre-formed dome cap reinforcements 40 that are structured to compensate for the deficiencies of tubular braiding. This is further explained in FIG. 3. For example, region 42 around the polar opening may have fiber angles in the 70-90 degree range with respect to the longitudinal axis of the pressure vessel. Predominantly circumferential reinforcement around the opening helps to prevent premature failure of the pressure vessel by the “boss blow-out” failure mode. Avoiding this failure mode results in a more efficient pressure vessel with higher burst pressure for a given amount for fiber reinforcement. Similarly, region 44 in the pre-formed dome cap may have angles in the 20-60 degree range, to provide more longitudinal stiffness in the critical knee area that transitions from the cylindrical portion of the pressure vessel to the end-dome, that is prone to “flower burst” failure mode. Delaying the boss blow-out and flower-burst failure modes serve to enhance the burst pressure of the pressure vessel and helps to reduce the weight and cost.

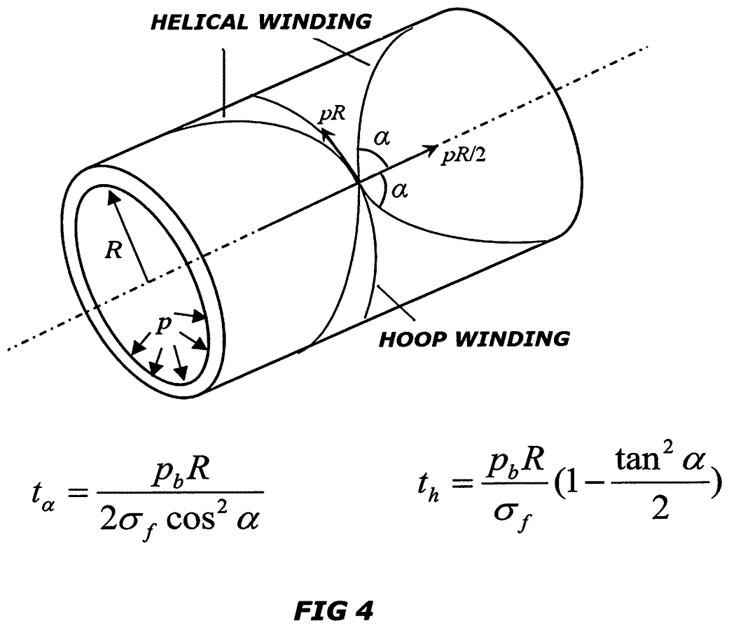

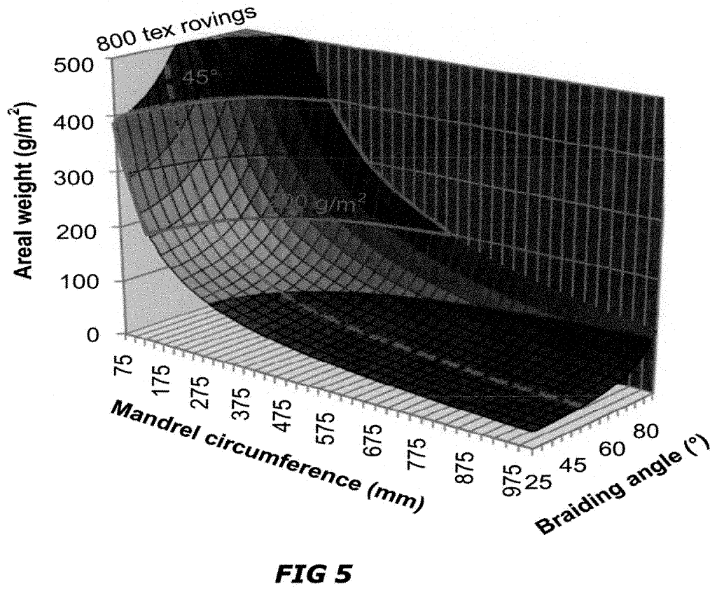

Netting analysis shown in FIG. 4 is a simplified approach for determining the approximate hoop and helical layer thicknesses (Equations 1 and 2 below). This approach ignores the effects of the resin matrix material and assumes only the fiber properties in the model. A balance of forces is used to determine the required thicknesses to support the applied pressure. The basis of analysis is:

$$\begin{matrix}{t}_{f Θ} = \frac{P R}{2 {σ}_{f Θ} {cos}^{2} AE Θ} & Equation 1 \\ {t}_{f 90} = \frac{PR}{2 {σ}_{f 90}} ( 2 - {tan}^{2} AE Θ ) E & Equation 2\end{matrix}$$

Where
P is the desired pressure at burst
R is the radius at the cylindrical section of the tank
r is the radius of fiber turn-around at the polar boss
σ_{f90} is the failure stress of the hoop fiber
σ_{f⊖} is the failure stresses of the helical fiber
⊖ is the helical winding angle, calculated using Eq. 3 below.

⊖=sin⁻¹(r/R) Equation 3

These thicknesses given in Equations 1 and 2 represent the pure fiber thicknesses and without the resin. To obtain the composite laminate thickness with the resin included, we simply use the rule of mixtures:

t_{lΘ}=t_{fΘ}/v_{f}A Equation 4

tₗ₉₀=t_{f90}/v_{f} Equation 5

As seen in these equations, the classical design of fiber-reinforced tanks or pressure vessels involve helical (nearly longitudinal or close to 0 degrees) and hoop (nearly circumferential or close to 90 degrees) fiber angles with respect to the longitudinal axis of the pressure vessel. Such angles can be readily achieved in filament winding, but difficult or impossible in braiding. The graph in FIG. 5 shows the dependencies of the braiding angle, mandrel circumference, and areal weight for different machine setups, whereas the feasible process windows in terms of braiding angle and areal weight are marked. Braiders are specialized for the manufacturing of fiber layers under a certain angle between about 20 degrees and 70 degrees.

The pre-formed endcaps disclosed in the present invention compensate for the inability of braiders to achieve close to 90-degree build up around the polar openings and longitudinal reinforcement at the dome knee regions.

A filament winding step may be beneficially added to the braiding process to laydown hoop layers on the straight cylindrical portion of the pressure vessel.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A compressed gas containment tank or pressure vessel comprising: an inner shell made of corrosion and permeation-resistant material; and a concentric outer shell constructed of high strength fiber-reinforcements that incorporates one or more pre-formed fiber-reinforced endcap(s).

2. The vessel of claim 1, wherein the pre-formed fiber-reinforced endcaps incorporate fiber angles in the range 70-90 degrees next to a polar opening.

3. The vessel of claim 1, wherein the pre-formed fiber-reinforced endcaps incorporate fiber angles in the range 10-70 degrees in the skirt or “knee” region adjacent to the straight cylindrical area of the vessel.

4. The vessel of claim 1, wherein the pre-formed fiber-reinforced endcaps are made by filament winding, braiding, fiber-placement or laminate layup techniques.

5. The vessel of claim 1, wherein the inner shell has a straight cylindrical portion and opposite dome portions, and wherein reinforcing fibers are filament-wound over the straight cylindrical portion and the dome portions overlaid with pre-formed endcaps.

6. The vessel of claim 1, wherein the inner shell has a straight cylindrical portion and opposite dome portions, and wherein reinforcing filaments are braided over the straight cylindrical portion and the dome portions overlaid with pre-formed endcaps.

7. The vessel of claim 1, wherein the inner shell comprises thermoplastic polymers such as polyethylene, nylon, ethylene vinyl acetate or ethylene vinyl alcohol copolymer.

8. The vessel of claim 1, wherein the inner shell comprises 6061 aluminum alloy.

9. The vessel of claim 1, wherein the reinforcing fiber is dry or impregnated with a polymer selected from the group consisting of thermosetting polymers such as epoxy and vinyl ester, and thermoplastic polymers such as polyethylene and polypropylene.

10. A pre-formed fiber-reinforced endcap with or without a polar opening and with fiber angles in the range 70-90 degrees next to a polar opening.

11. The pre-formed endcap of claim 10, wherein the reinforcing fibers are incorporated by filament winding, braiding, fiber-placement or laminate layup techniques.

12. A pre-formed fiber-reinforced endcap with or without a polar opening and with fiber angles in the range 10-70 degrees in the skirt or “knee” region to be placed on an inner shell or core or a tank or pressure vessel and overwrapped with reinforcing fiber during the manufacture of the tank or vessel.

13. The pre-formed endcap of claim 12, wherein the reinforcing fibers are incorporated by filament winding, braiding, fiber-placement, or laminate layup techniques.
